(19) United States
(12) Patent Application Publication
(10) Pub. No.: US 2004/0035496 A1
(43) Pub. Date: Feb. 26, 2004

(54) Wood splitter

(76) Inventor: Lutz H. Ritzmann, (US)

Correspondence Address: Samuels, Gauthier & Stevens LLP, Suite 3300, 225 Franklin Street, Boston, MA, 02110, US

(21) Appl. No.: 10/445,785

(22) Filed: May 27, 2003

(30) Foreign Application Priority Data
May 24, 2002 (DE) 202 08 117.6
Jul. 11, 2002 (DE) 102 51 835.1

(51) Int. Cl. B27L 7/00

(52) U.S. Cl. 144/193.2

(57) ABSTRACT

A wood splitter which comprises a splitting wedge having a splitting edge and a back secured to a guide rod. An impact weight cross-sectionally surrounds the guide rod and is slidable along the length of the guide rod. The splitting wedge has a twisted shape extending from the splitting edge to the back which facilitates the passage of the splitting wedge through a log to be split when driven by the impact weight.

### PRIORITY DATA

This application claims the benefit of German Pat. Appln. No. 202 08 117,6, filed on May 24, 2002, and German Pat. Appln. No. 102 51 835,1, filed on Jul. 11, 2002.

### BACKGROUND OF THE INVENTION

The present invention relates to a wood splitters and in particular to wood splitters having impact weights that drive a splitting wedge into a log to be split.

Conventional wood splitters include a splitting wedge, a guide rod connected to the splitting wedge, and an impact weight that cross-sectionally surrounds the guide rod. The impact weight is slidable lengthwise along the guide rod. In order to split a log, the splitting wedge is placed on the log. The user of the wood splitter raises the impact to the upper end section of the guide rod and then drops the impact weight onto the splitting wedge such that the splitting wedge is driven into the log to be split in response to the kinetic energy of the falling impact weight. If necessary, the user may not only simply drop the impact weight from the upper position but may also impart additional acceleration to the weight by hand force. As a result, the kinetic energy of the falling impact weight is increased.

The splitting wedges of the conventional wood splitters have been designed to expand upwardly from the splitting edge to form a V-shape. The sides of the splitting wedges are essentially flat thereby making the design of the splitting wedges resemble the design of conventional axes.

A drawback associated with the use of a conventional wood splitter is that in many cases the splitting wedge does not completely split the log upon being struck for the first time by the impact weight whereupon the splitting wedge remains lodged within the partially split log.

The present invention addresses the aforementioned drawback.

### SUMMARY OF THE INVENTION

The invention features a wood splitter comprised of a splitting wedge having a twisted geometry, a guide rod connected to the splitting wedge and an impact weight which cross-sectionally surrounds the guide rod and is slidable lengthwise along the guide rod. The twisted geometry of the splitting wedge starts from the splitting edge of the splitting wedge and extends upwardly toward the back of the wedge.

The twist geometry of the splitting wedge, which creates a continually increasing expansion of the effective width of the splitting wedge from the splitting edge and extending upwardly toward the back of the wedge, allows the splitting wedge to have the same wedge angle as conventional splitting wedges but with a greater effective width. When driven into a log, the splitting wedge provides a larger split in the log than that of conventional splitting wedges having the same wedge angle because of its greater width thereby reducing the instances of jamming the splitting wedge in the log.

The splitting wedge is preferably a forged piece. The twist, i.e., the curl, of the side of the splitting wedge which extends from the cutting edge to the wedge back is in the range of between about 20° and 90° so as to improve its splitting effect.

In another aspect of the invention, the impact weight is comprised of at least two detachably connected individual components. By modifying the number of impact components used, the impact force applied to the splitting wedge can be modified. If, for example, the objective is to split pieces of wood which are small or soft, only one impact component of the impact weight would be required. If, on the other hand, greater splitting forces are required to split larger, harder pieces of wood, more than one impact component of the impact weight would be required thereby increasing the force applied to the splitting wedge. The number of impact components utilized may also be dictated by the strength of the user of the wood splitter.

In another aspect of the invention, the impact components are interconnected and rest in tandem against each other along the lengthwise axis of the guide rod. As a result, the overall impact weight is relatively compact thereby eliminating the risk that under unfavorable circumstances the impact weight could jam in the wood to be split.

In yet another aspect of the invention, the impact components have an internal thread oriented concentrically relative to the guide rod and a threaded stem also oriented concentrically relative to the guide rod. Alternatively, the impact components can be configured to have bayonet-type connections such that the impact components may be interconnected.

In another aspect of the invention, the impact components can comprise permanent magnets such that the impact components are interconnected to each other by magnetic force.

In yet another aspect of the invention, a spacer sleeve is slidably received onto the guide rod. The spacer sleeve is positioned between the splitting wedge and the impact weight. The spacer sleeve allows the distance between the splitting wedge and impact weight to be increased thereby reducing the risk that the impact weight might become wedged in the wood.

In another aspect of the invention, the spacer sleeves comprises at least two spacer sleeves positioned in a tandem relationship. The distance between the splitting wedge and the lowest position of the impact weight may be varied so that wood pieces of differing heights may be split without the risk that the impact weight might wedge inside the wood piece.

These and other objects, features and advantages of the present invention will become more apparent in light of the following detailed description of the preferred embodiments thereof, as illustrated in the accompanying drawings.

### BRIEF DESCRIPTION OF THE DRAWINGS

FIG. 1 a perspective view of a wood splitter embodying the invention;

FIG. 2 is perspective view of a splitting wedge of a wood splitter embodying the invention;

FIG. 3 is longitudinal sectional view of an impact weight of a wood splitter embodying the invention;

FIG. 4 is partial longitudinal sectional view of a splitting wedge secured to an impact weight of a wood splitter embodying the invention;

FIG. 5 is a partial sectional view of an impact weight of a wood splitter embodying the invention;

FIG. 6 is a partial sectional view of an impact weight of a wood splitter embodying the invention;

FIG. 7 is a sectional view taken along lines VI-VI of FIG. 6; and

FIG. 8 is a partial sectional view of a splitting wedge secured to a guide rod of a wood splitter embodying the invention.

### DETAILED DESCRIPTION OF THE INVENTION

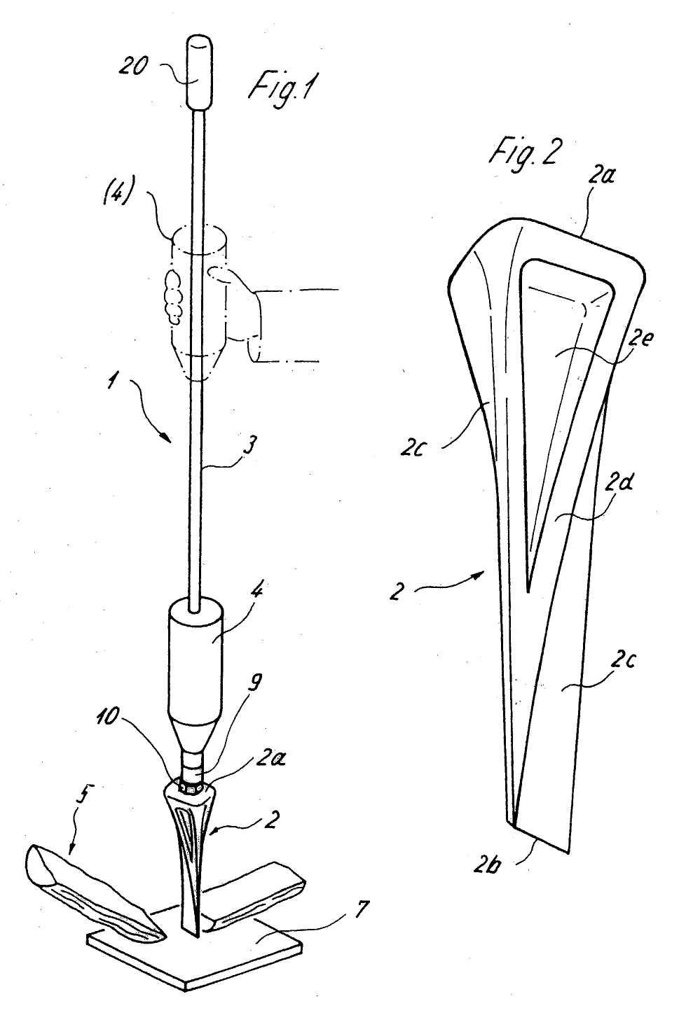

Referring to FIG. 1, a wood splitter 1 is shown which comprises a splitting wedge 2, a guide rod 3 and an impact weight 4. The splitting wedge 2, the guide rod 3 and the impact weight 4 are constructed of a durable material, e.g., metal. Guide rod 3 is detachably secured to the wedge back 2a of the splitting wedge 2. Impact weight 4 surrounds guide rod 3 and is slidable lengthwise along guide rod 3. In addition, a handle element 20 is located on the upper end section of guide rod 3. The handle element 20 can be used to align guide rod 3. Handle element 20 can be slid onto or clamped onto guide rod 3. Other suitable ways to fasten handle element 20 onto the guide rod 3 can also be employed.

Impact weight 4 is raised along guide rod 3, as indicated by the dashed lines in FIG. 1, and is then subsequently released or accelerated by hand so that the impact weight 4 falls onto splitting wedge 2. The kinetic energy of the falling impact weight is transferred to the splitting wedge 2 and the splitting wedge 2 is driven into a log 5 to be split. The splitting wedge 2 which is driven into the log 5, e.g. a tree trunk, splits the log 5 into two halves.

The section of the log 5 to be split may be placed on a base plate 7 or directly on a lawn. The cutting edge 2b of splitting wedge 2 may be placed on top of the log 5 to be split. By placing the section of log 5 to be split on the ground, the entire length of the guide rod 3, which can be greater than 1 m, e.g., 1.2 m, is utilized such that the impact weight 4 can be dropped a distance of substantially the entire length of the guide 3 thereby increasing the splitting force of the wood splitter 1. In addition, the risks related to operating wood splitter 1 are reduced since there is no wobbly log onto which the wood piece to be split is placed and the splitting process occurs at a lower level where it is less risky for the operator.

The end of guide rod 3 opposite splitting wedge 2 may also be closed off, for example, by a hat-like cap (not shown) screwed on to guide rod 3. The caps prevents the impact weight 4 from unintentionally sliding off the guide rod 3.

Referring to FIG. 2, the splitting wedge 2 has a twisted shape extending in a direction from the splitting edge 2b to the wedge back 2a. The splitting edge 2b is of the conventional straight design, while the sides 2c of splitting wedge 2 have a pronounced twisted shape starting from the straight splitting edge 2b and extending upwardly in the direction of the wedge back 2a. Splitting wedge 2 is preferably a forged piece.

The twist of splitting wedge 2 may extend 90° over its length such that side 2c, which is adjacent to splitting edge 2b, arrives at an offset in the region of wedge back 2a. From the top view, wedge back 2c is essentially rectangular, and side 2c terminates at an adjacent side of wedge back 2a. In order to reduce the dead weight of splitting wedge 2, a triangular recess 2e may be provided in one side wall 2d of splitting wedge 2.

Referring to FIGS. 1 and 4, a sleeve 10, e.g., a lock nut, is positioned on wedge back 2a. Guide rod 3 is threadably received into the sleeve 10 thereby allowing the user to attach or detach the guide rod 3 to the splitting wedge 2 with ease.

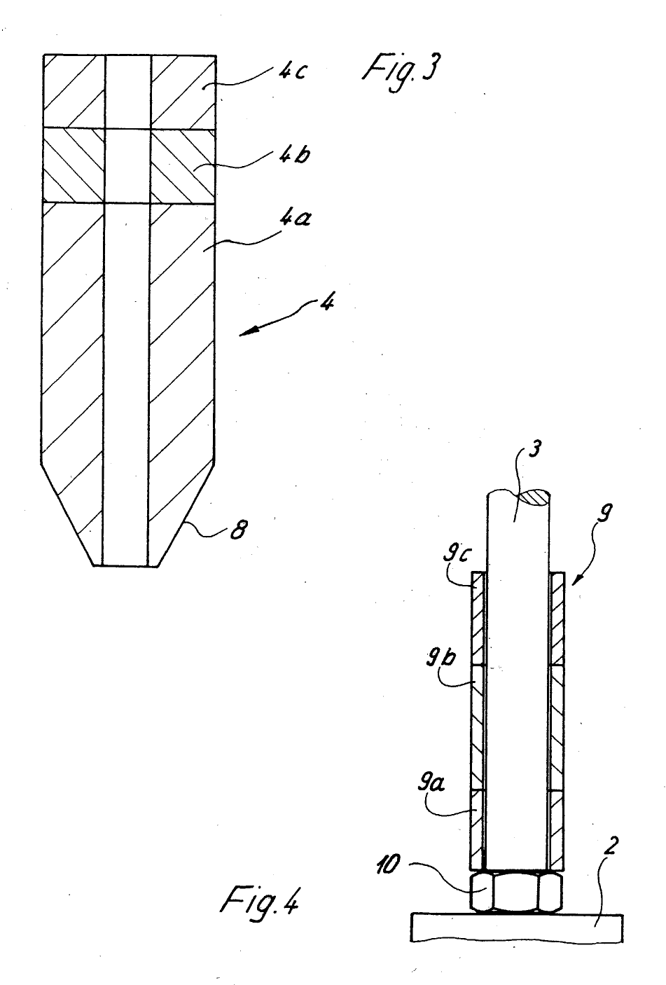

Referring to FIG. 3, a sectional view of an impact weight 4 taken along its length is shown. The impact weight, which can be adjusted to control the splitting force of the wood splitter 1, is comprised of a base 4a, a first impact component 4b and a second impact component 4c. The base 4a, the first impact component 4b and the second impact component 4c can be attached and detached from each other with ease. For example, in the embodiment shown in FIG. 3, base 4a and the first and second impact components can be magnets that are attracted and attached to each other by magnetic force. Alternatively, only interfacing portions of base 4a, the first component 4b and the second components 4c comprise magnets. Although this embodiment has been described with respect to first and second impact components 4b and 4c, the invention also contemplates the addition of more impact components (not shown) that could be placed in tandem above second impact component 4c. The base 4a includes a conical chamfer 8 which prevents wedging of the impact weight 4 in the wood to be split.

Referring to FIG. 4, a spacer sleeve 9 is slidably received on the guide rod 3. The spacer sleeve 9 is positioned between splitting wedge 2 and impact weight 4 when splitting long pieces of wood. The spacer sleeve 9 has a first sleeve section 9a, a second sleeve section 9b and a third sleeve section 9c positioned in tandem. The sleeve sections 9a through 9c can be removed or added by the user of the wood splitter thereby allowing varying distances to be created between the splitting wedge 2 and the impact weight 4.

FIG. 4 shows a complete spacer sleeve 9 comprised of sleeve sections 9a through 9c. FIG. 1 shows a spacer sleeve only comprised of sleeve sections 9a and 9b located on guide rod 3.

Referring to FIG. 5, an alternative embodiment of detachably connecting base 4a and first impact component 4b of impact weight 4 is shown. Base component 4a is provided with an internal thread 13 concentric with guide rod 3. Internal thread 13 interfaces with first impact component 4b by a threaded stem 11 which is similarly concentric with guide rod 3. These features are used to screw base 4a and first impact component 4b of impact weight 4 together.

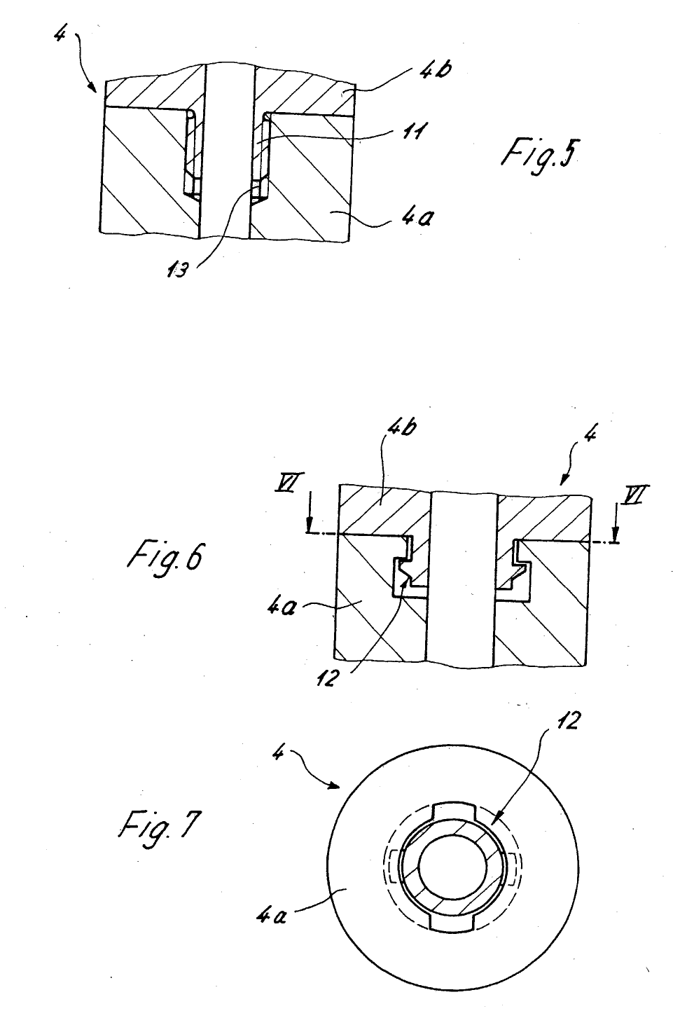

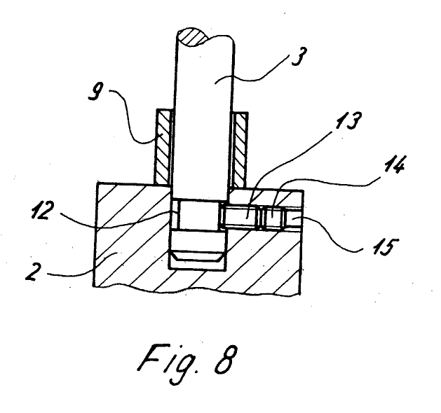

Another alternative technique for connecting base 4a and first impact component 4b of impact weight 4 is shown in FIGS. 6 and 7.

FIGS. 6 and 7 show that a connection between base 4a and first impact component 4b of impact weight 4 may also be implemented by a bayonet connector 12.

Referring to FIG. 8, a partial sectional view of a splitting wedge secured to a guide rod of a wood splitter embodying the invention is shown. The lower end of the guide rod 3 has a ring-shaped groove 20 which is surrounded by a section of the splitting wedge 2. A threaded hole 15 is provided in splitting wedge 2. A threaded bolt 13 with a hexagonal socket is inserted into the threaded hole 15. The front end of threaded bolt 13 engages groove 12, thereby ensuring a strong connection between the splitting wedge 2 and the guide rod 3. The threaded bolt 13 is secured by an additional threaded bolt 14 which is also screwed into threaded hole 15 and secured by threaded bolt 13.

As shown in FIG. 8, only one threaded bolt 13 is screwed into groove 12. It is of course contemplated that additional threaded bolts 13 could be arranged circumferentially around the guide rod 3 screwed into appropriate threaded holes 15 in the splitting wedge 2. In addition, instead of being connected directly to the splitting wedge 2, the threaded bolt 13 may also be connected to a component attached to splitting wedge 2, for example a sleeve.

Although the present invention has been shown and described with a preferred embodiment thereof, various changes, omissions and additions to the form and detail thereof, may be made therein, without departing from the spirit and scope of the invention.

What is claimed:

1. A wood splitter which comprises:
a splitting wedge having a splitting edge and a back secured to a guide rod; and
an impact weight which cross-sectionally surrounds said guide rod and is slidable along the length of said guide rod, said splitting wedge having a twisted shape extending from said splitting edge to said back.

2. The wood splitter according to claim 1 wherein said splitting wedge is a forged piece.

3. The wood splitter according to claim 2 which further comprises a sleeve, said guide rod being received in said sleeve.

4. The wood splitter according to claim 3 wherein said sleeve is threaded and said guide rod is threadably received in said sleeve.

5. The wood splitter according to claim 1 wherein said splitting edge is linear.

6. The wood splitter according to claim 1 wherein said impact weight comprise a first part interconnected with a second part, said parts being positioned in tandem along the length of said guide rod.

7. The wood splitter according to claim 6 wherein said first and second parts are detachable.

8. The wood splitter according to claim 7 wherein said first part has a threaded portion concentric with said guide rod and said second part has a threaded portion concentric with said guide rod, said second part being threadably received into said first part.

9. The wood splitter according to claim 6 wherein said first part has a first portion and said second part has a second portion, said first portion and said section portion adapted to form a bayonet connection between said first part and said second part.

10. The wood splitter according to claim 6 wherein said first and second parts are magnets.

11. The wood splitter according to claim 1 which further comprises a spacer sleeve slidably received onto said guide rod and positioned between said splitting wedge and said impact weight.

12. The wood splitter according to claim 1 wherein the impact weight has a front end, said front end comprising a conical chamfer.

13. The wood splitter according to claim 1 wherein said splitting wedge comprises a top surface having a bore therein and a side surface having a channel formed therethrough, said bore being in communication with said channel and wherein said guide rod has a grooved end, said bore adapted to receive said guide rod.

14. The wood splitter according to claim 13 which further comprises a threaded bolt, said threaded bolt passing through said channel and being threadably received into said grooved end to fasten said guide rod to said splitting wedge.
